(19) United States
(12) Patent Application Publication
(10) Pub. No.: US 2023/0176350 A1
(43) Pub. Date: Jun. 8, 2023

(54) MULTIPLE FIELDS-OF-VIEW LENS

(71) Applicant: Samsung Electronics Co., Ltd., Suwon-si (KR)

(72) Inventors: Stepan Evgenievich IVANOV, Saint-Petersburg (RU); Vladislav Vladimirovich DRUZHIN, Moscow (RU); Andrey Alexandrovich MANKO, Moscow (RU)

(73) Assignee: Samsung Electronics Co., Ltd., Suwon-si (KR)

(21) Appl. No.: 17/994,786

(22) Filed: Nov. 28, 2022

(30) Foreign Application Priority Data
Dec. 3, 2021 (RU) 2021135682
Jul. 22, 2022 (KR) 10-2022-0091264

(51) Int. Cl. G02B 17/06; G02B 5/02; G02F 1/31; G02B 27/00

(52) U.S. Cl. CPC G02B 17/061; G02B 5/0294; G02F 1/31; G02B 27/0081

(57) ABSTRACT

The present disclosure relates to an optical field and more particularly, to a multi-field of view (FOV) (zooming) optical assembly for a lens and may include an optical element provided in a form of a solid main optical element and including an integrated focal system with two mirrors and at least one integrated afocal system with two mirrors, a plurality of switching optical elements (SOEs) arranged on a front face of the optical element and configured to be switched between an open state in which light is transmitted and a closed state in which light is reflected and/or inhibited, and an image plane curvature correction element.

### CROSS-REFERENCE TO RELATED APPLICATIONS

This application claims priority from Russian Patent Application No. 2021135682, filed on Dec. 3, 2021, at the Russian Federal Service for Intellectual Property, and Korean Patent Application No. 10-2022-0091264, filed on Jul. 22, 2022, at the Korean Intellectual Property Office, the disclosures, all of which, are incorporated herein by reference in their entireties.

### BACKGROUND

### 1. Field

The following description relates to an optical system of a multiple fields of view (FOV) imaging lens suitable to be used, for example, in an imaging device such as a photo/video camera included in a compact electronic device, although the imaging lens may be suitable for many types of imaging devices and/or apparatuses incorporating same.

### 2. Description of Related Art

As a non-limiting example, with the advent of compact computing devices such as mobile phones, smartphones, tablet computers, personal digital assistants (PDAs), communicators, netbooks, and laptops, a need to provide image capturing elements for devices, such as photo/video cameras, has arisen to implement various functions related to capturing still images and videos, video communications, user face recognition, “computer vision”, and the like, in response to a user command. As such, a need to change (“zoom”) a field of view of a lens for image capturing has arisen. Conventional lenses for photo cameras in which zooming (change in field of view) is implemented by moving elements, such as lenses and lens groups, are not suitable for use in compact computing devices due to their large dimensions.

As is known in the field of variable focus lenses, in order to change a field of view (hereinafter also referred to by “FOV”), a focal length of a lens may be physically changed by moving one or more of optical system components, multiple lenses or cameras, each having its own focal length parameters, may be used as necessary under the control of software, and if possible, seamless switching between lenses (cameras) without any “abrupt” FOV modification of the lenses (cameras) recognizable by a user may be provided.

Lenses with movable optical system components may require a highly precise optical system assembly as well as highly precise structural elements that may provide tolerances required for an optical system in a range of variable focal length values. A combined variant is also possible. Multiple switchable lenses or cameras may be used to cover the entire required range of focal lengths, and each of the lenses or cameras may use a group of moving optical system elements. In this case, multiple assemblies with significantly high assembly precision, each including multiple optical elements, may be used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A compact lens may be provided with a variable field of view (FOV) (focal length) without necessarily requiring moving optical system components and with a simple structure and assembly that may not require moving optical system components that often require precise manufacture and assembly.

A lens may provide multiple FOVs with a high degree of aberration correction in an optical system without moving necessarily requiring optical components.

An optical assembly may allow switching between multiple FOVs.

In one general aspect, an optical assembly may include an optical element provided in a form of a solid main optical element and comprising an integrated focal system with two mirrors and at least one integrated afocal system with two mirrors, a plurality of switching optical elements (SOEs) arranged on a front face of the optical element and configured to switch between an open state in which light is transmitted and a closed state in which visible spectrum light is reflected and/or inhibited, and an image plane curvature correction element.

The focal system may include a first concave reflective optical surface and a second convex reflective optical surface.

The at least one afocal system may include at least a first concave reflective optical surface and a second convex reflective optical surface.

The first concave reflective optical surface and the second convex reflective optical surface may be applied with a coating of which a state changes between a transmissive state and a reflective state.

The focal system and the at least one afocal system may be provided in the solid main optical element.

The SOEs may be configured to compensate for curvature of at least one concave surface of the afocal system to form a substantially flat forward face portion of the optical element.

At least one surface of the SOEs may be applied with a reflective optical coating.

At least one surface of the SOEs may be applied with an electrochromic glass (ECG) coating.

The SOEs may be made of a same optical material as the main optical element.

The SOEs may have a flat first optical surface and a second optical surface having curvature corresponding to curvature of a concave optical reflective surface of the focal system and/or the at least one afocal system.

The SOEs may be arranged on a second reflective optical surface of the at least one afocal system to form a flat surface arranged perpendicular to an optical axis.

The optical element may have a recessed concave central circular portion.

The image plane curvature correction element may be provided in a form of at least one lens and arranged between the optical element and an image sensor of an imaging sensor.

In another general aspect, an imaging device may include an optical assembly, wherein the optical assembly may include an optical element provided in a form of a solid main optical element and comprising an integrated focal system with two mirrors and at least one integrated afocal system with two mirrors, a plurality of switching optical elements (SOEs) arranged on a front face of the optical element and configured to switch between an open state in which light is transmitted and a closed state in which light is reflected and/or absorbed, and an image plane curvature correction element arranged behind the optical element.

In another general aspect, an imaging device includes an optical assembly, the optical assembly includes: a front side that includes(i) a first annular portion that includes a first optical switch configured to control transmissivity of the first annular portion, and (ii) a second annular portion that includes an annular recess with an internally-convex surface and a second optical switch configured to control turn mirroring of the internally-convex surface on and off; and a rear side that includes (i) a third annular portion that includes a first internally-concave mirrored surface configured to reflect light transmitted through the first annular portion, and (ii) a fourth annular portion that includes a second internally-concave mirrored surface configured to reflect light transmitted through the second annular portion.

In another general aspect, a method of generating multiple FOVs in an imaging lens may include transmitting light incident to a solid main optical element through two SOEs arranged on a front face of an optical element, and switching between which FOV is provided to an image sensor by switching each of the two SOEs between an open state in which the SOEs transmit light and a closed state in which the SOEs reflect and/or inhibit light transmission, wherein, in the transmitting of the light incident to the solid main optical element, the incident light may be reflected internally at least once due to a focal system with two mirrors integrated into the optical element and at least one afocal system with two mirrors integrated into the optical element, and is out-coupled onto the image sensor to provide multiple FOVs for the image sensor.

The method may further include correcting image curvature generated in the image sensor using an image plane curvature correction element arranged between the optical element and the image sensor.

The switching between the FOVs in the image sensor may include switching one of the SOEs to the open state and the other SOE to the closed state.

The SOEs may be configured to compensate for curvature of at least one recessed concave surface of the afocal system to form a substantially flat forward face of the optical element.

At least one surface of the SOEs may be applied with a reflective optical coating.

At least one surface of the SOEs may be applied with an ECG coating.

Other features and aspects will be apparent from the following detailed description, the drawings, and the claims.

### BRIEF DESCRIPTION OF THE DRAWINGS

FIG. 1 is a cross-sectional view illustrating an example of a portion of an optical assembly, according to one or more embodiments.

FIGS. 2A through 2C illustrate examples of switching of a field of view (FOV) carried out through a switching optical element (SOE), according to one or more embodiments.

FIG. 3 illustrates a cross-section of an example of a focal system with two mirrors and at least one afocal system with at least two mirrors of an optical assembly, according to one or more embodiments.

FIG. 4 is a cross-sectional view illustrating an example of a portion of an optical assembly of which a surface to which a switching optical coating is applied is marked, according to one or more embodiments.

FIG. 5 is a front perspective view illustrating an example of an optical assembly, according to one or more embodiments.

FIG. 6 illustrates an example of switching an FOV in an optical assembly depending on a state of an SOE, according to one or more embodiments.

FIG. 7 is a flowchart illustrating an example of a process of providing multiple FOVs through an imaging lens, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

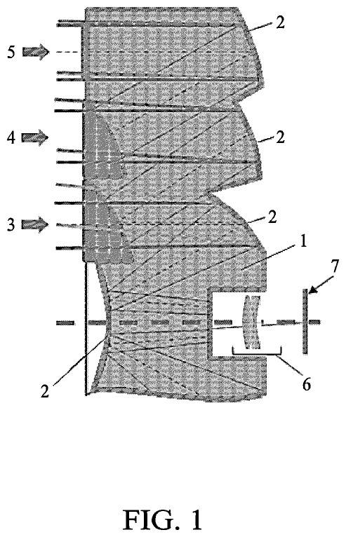

Hereinafter, an imaging lens capable of generating multiple FOVs and a method thereof will be described in detail with reference to FIGS. 1 through 7.

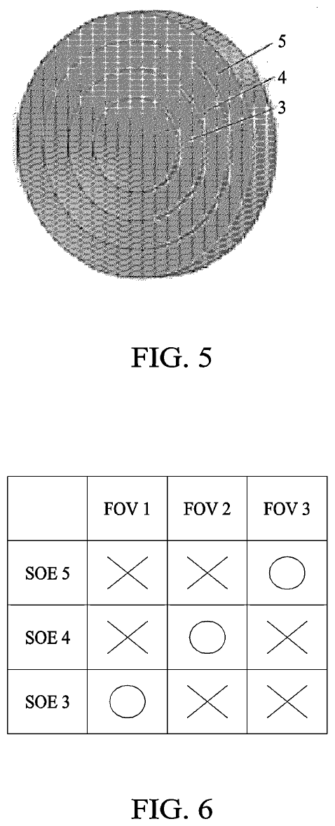

The present disclosure relates to a multi-FOV (zooming) optical system to be used in an imaging (image capturing) device (“imaging lens”). The above-mentioned optical system may be also referred to as an optical assembly. A lens including an optical assembly may be referred to as an “annular” imaging lens based on an implementation form of an SOE. In an example, viewed from a front face thereof, an optical assembly may be a substantially concentric ring as illustrated in FIG. 5. FIG. 5 is a front perspective view illustrating an example of an optical assembly.

FIG. 1 is a cross-sectional view illustrating an example of a portion of an optical assembly.

A basis of an optical assembly is an optical element 1 made in a form of a solid main optical element. In addition, the optical assembly may also include an image plane curvature correction element 6 and an image sensor 7.

Mirror coatings 2 may be applied to a designated surface of the optical element 1 (e.g., on the right outer surface of the optical element 1). The optical element 1 may be capable of generating several different FOV channels by virtue of one or more annular curved portions on a front face of the optical element 1 (the left side of optical element 1 in FIG. 1).

The curved portions may have a shape of a concentric rings on the front face of the optical element 1. The concentric rings may include one or more curved portions, each of which may be substantially in a form of an annular recess on the front face of the optical element 1 and having a concave surface (recessed with a tilt toward the center of the optical element 1). The concentric rings may also include at least one flat annular surface which is oriented parallel to a plane of the front face of the optical element 1 (i.e., a normal of the surface is parallel to the optical axis of the optical element 1). The flat annular surface may be an outermost of the concentric rings. In some embodiments, a flat annular surface may be omitted.

The concentric rings of the front face of the optical element 1 may be filled with SOEs 3, 4, and 5 which compensate for the recessed curvature of the curved portions by filling each of the recessed curved portions of the surface. Accordingly, the curved portions may be compensated for such that front faces of the SOEs 3, 4, and 5 may form substantially one planar surface (or respective annular planar surfaces) with the front face of the optical element 1. Where the SOEs 3, 4, and 5 are located may correspond to a direction of the front face of the optical element 1.

Each of the SOEs 3, 4, and 5 may provide its own respective FOV channel. It should be noted that an example describes a case in which there are three FOVs and three SOEs, but there may be two SOEs or more than three SOEs and a same number of respective FOVs.

Description of one arbitrary SOE and its corresponding FOV channel may suffice for description of other SOEs and their FOV channels.

The main optical element of the optical assembly may enable simultaneous generation of multiple images which correspond to different respective FOVs in the image sensor 7. Using SOEs, these images may be separated into different FOVs, and a required image may be generated in the image sensor. Thus, an FOV of the optical assembly may be substantially changed for the same image sensor 7. In an example, multiple (two or more) different FOVs are provided, thus changing the FOVs may provide be a function of changing a camera's FOV (“zooming”).

Switching of different FOV channels may be performed through each SOE. Each SOE may include at least one surface capable of changing one or more optical properties such as light transmissibility, reflectivity, and/or absorption properties. “Switching” of each SOE may be performed through the at least one surface, and accordingly, each SOE may be considered “open” or “closed” to light. The “switching” may be implemented using a coating applied to a surface of each SOE. A type of coating applied to the surface of each SOE may be a liquid crystal switchable mirror (LCSM) and an electrochromic mirror (ECM). Such a mirror's optical state may be switchable through an electronic circuit that controls a voltage of a transparent electrode may be switched between a reflective semi-transparent state and a nearly transparent state. An example of an ECM may be a suspended particle display (SPD) which is a device including particles suspended in a liquid. In an SPD device, a switching effect may be achieved by controlling directions of rod-shaped particles between two transparent electrodes to electronically adjust light absorption. A cholesteric liquid crystal (CLC) may be an example of an LCSM. When a ray travels along an axis of a spiral, Bragg reflection occurs in a wavelength range of no*P≤λ≤ne*P. In this range definition, “P” denotes a CLC pitch, “no” denotes an ordinary refractive index, and “ne” denotes a non-ordinary refractive index. Left-hand circular polarized light incident on a CLC with a right-hand spiral may be transmitted without reflection. On the other hand, the left-hand circular polarized light incident on a CLC with a left-hand spiral may be totally reflected.

A reflective state of a CLC mirror may be effectively switched by a square low voltage wave. In general, molecules may have sufficient time within 10 milliseconds (msec) to partially rotate to generate an inclined texture, and thus a partially reflective state may be achieved. In addition, in general, molecules may turn completely vertical within 20 msec, and thus a completely transparent state may be achieved. In an initial state, a CLC may be a Bragg mirror that is totally reflective within a wavelength range λ.

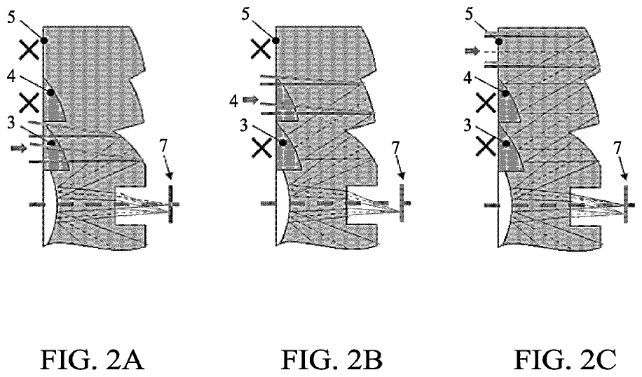

An operating principle of an optical assembly is further described with reference to FIGS. 2A through 2C, and 6, which illustrate examples in which three SOEs are used and three FOVs are implemented.

FIGS. 2A through 2C illustrate examples of switching of an FOV carried out through switching of an SOE. FIGS. 2A, 2B, and 2C illustrate examples of generation of a first FOV (FOV1), a second FOV (FOV2), and a third FOV (FOV3), respectively. The states of the SOEs are represented by “X”s or lack thereof, where an “X” indicates a closed SOE.

FIG. 6 illustrates an example of switching an FOV in an optical assembly depending on a state of an SOE. FIG. 6 is a table showing switching of respective FOVs depending on “open” and “closed” states of respective SOEs.

Referring to FIG. 2A, an SOE 3 may be switched to an “open” (“transparent”) mode. Light that has passed through the SOE 3 is be subjected to total/high reflection in the optical element 1 (e.g., reflecting off the mirrored back surface or others) and eventually reaches the image sensor 7 which generates an image with the FOV1 (see FIG. 6). In this case, an SOE 4 and an SOE 5 may be in a “closed” state (each coating reflects and/or absorbs/inhibits light).

In a scenario of FIG. 2B, the SOE 4 may be in an “open” state; the SOE 3 and the SOE 5 are in a “closed” state. Incident light may enter the optical element 1 through the SOE 4, be reflected, in particular, from the “closed” SOE 3, and eventually reach the image sensor 7 after being reflected internally several times within the optical element 1. It should be noted that internal reflection is defined by the mirror coatings 2 present on the front and rear faces of the optical element 1 (see surfaces 2 in FIG. 1). Before reaching the image sensor 7, the light may be reflected internally more times than the light passing through the open SOE 3 as illustrated in FIG. 2A. In this way, a length of an optical path of the light within the optical element 1 may increase, and thus, it may be possible to implement a longer focal length compared to the case in which the SOE 3 is “open”. An image with a different FOV (FOV2) may be generated by the image sensor 7 as compared to the scenario of FIG. 2A.

In a scenario of FIG. 2C, the SOE 5 may be in an “open” state, and the SOE 3 and the SOE 4 are in a “closed” state. Incident light may enter the optical element 1 through the open SOE 5 and be reflected internally many more times within the optical element 1 on a path to the image sensor 7. In the scenario of FIG. 2C, an optical path of the light may be still longer than the optical paths described with reference to FIGS. 2A and 2B, and an image with a different FOV (an FOV3 of FIG. 6) may be generated in the image sensor 7.

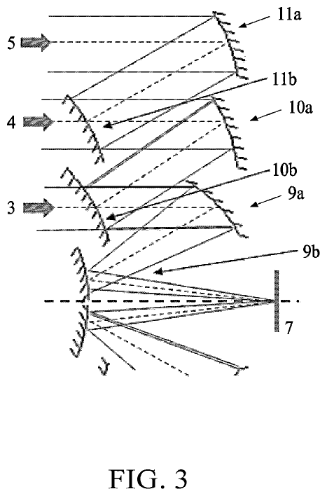

FIG. 3 illustrates a cross-section of an example of an optical assembly that includes a focal system having a first pair of mirrors and at a first afocal system with having a second pair of mirrors. There may be additional afocal systems. The first pair of mirrors is a first concave mirrored rear optical surface 9a and a convex mirrored central surface 9b. The second pair of mirrors is a second concave mirrored rear optical surface 10a and a first convex mirrored front optical surface 10b. A third pair of mirrors for a second afocal system includes a third concave mirrored rear optical surface 11a and a second convex mirrored front optical surface 11b. The first convex mirrored front optical surface 10b may become mirrored (or may be additionally mirrored) when SOE 3 is “closed”. Similarly, the second convex mirrored front optical surface 11b may become mirrored (or may be additionally mirrored) when SOE 4 is “closed”. Referring to FIG. 3, an optical structure of the main optical element 1 of an optical assembly may have some of the following characteristics.

When SOE 3 is controlled to be “open” and SOEs 4 and 5 are controlled to be “closed”, a first (wide) FOV may be provided by a focal system with the first pair of mirrors, i.e., the first concave mirrored rear optical surface 9a (on a rear face of the optical element 1) and the convex mirrored central surface 9b (on a front face of the optical element 1). External light incident on the optical element 1 passes through the “open” SOE 3 (with little or no bending/diffraction as it enters the optical element 1), reaches the first concave mirrored rear optical surface 9a which reflects and converges the light within the optical element 1 to the convex mirrored central surface 9b. The convex mirrored central surface 9b reflects the light further through the interior of the optical element 1 and focuses the light on the image sensor 7. Note that the terms “convex” and “concave” as used herein refer to a shape of an optical surface relative to the direction that the surface receives and reflects light rather than whether it is physically recessed within, or physically protrudes from, the material of the optical element 1.

Structure of the first pair of mirrors (optical surfaces) of the focal system described above may be based on the Ritchey-Chretien system characterized by absence of third order coma and spherical aberration. Astigmatism may be reduced to an acceptable value due to an aspherical shape of a mirror surface. Image curvature may be corrected by an image plane curvature correction element arranged between the convex mirrored central surface 9b and an image plane. The above-described focal optical system may have no basic geometrical aberration and provide image quality in a focal plane that may be limited by diffraction.

When SOE 4 is “open” and SOEs 3 and 5 are “closed”, a second (narrower) FOV may be provided by adding the first afocal system to the focal system. Specifically, the second pair of mirrors (the second concave mirrored rear optical surface 10a and the first convex mirrored front optical surface 10b) is combined with the first pair of mirrors, as illustrated in FIG. 3. Adding the first afocal system of the second pair of mirrors to the focal system of the first pair of mirrors allows an image to have a magnification M1 as compared to the first (wide) FOV described above.

For the second FOV (see FOV2 of FIG. 6), external incident light may pass through the “open” SOE 4 (with little or no bending/diffraction as it enters the optical element 1), reach the second concave mirrored rear optical surface 10a, reflect internally therefrom and converge to be reflected from the second convex mirrored front optical surface 10b. The second convex mirrored front optical surface 10b may collimate the light and reflect the light onto the first concave mirrored rear optical surface 9a of the focal system with the first pair of mirrors.

When SOE 5 is “open” and SOEs 3 and 4 are “closed”, the second afocal system of the third pair of mirrors is added to generate an image with another FOV (FOV3) and another image magnification value (Mn). In general, an operating principle of the third afocal system may be similar to that of the second afocal system of the second pair of mirrors described above. The third afocal system of the third pair of mirrors may reflect collimated light onto the second convex mirrored front optical surface 10b of the above-described second afocal system.

As described above, a combination of the focal system of a pair of mirrors and one or more afocal systems (of one or more respective pairs of mirrors) may provide a cascade optical system which is based on a combination of focal and afocal points, such that a compact optical system may be provided, and multiple different FOVs may be generated. The number of afocal systems combined with the focal system may be varied, for example, by the “opening” and “closing” of SOEs. An optical system capable of optical zooming, which generates multiple FOVs, may be thin. A beneficial technical effect may be the ability to provide an optical system based on one solid main optical element that is capable of switching FOVs without using a group of moving optical elements, which can obviate the need to use multiple lenses/cameras for different optical FOVs. In some implementations, the main optical element may be constructed from different parts, however, in such implementations the parts of the main optical element should have a same or similar material and/or a same or similar index of refraction.

The SOEs 3, 4, and 5 may be arranged on (and within) the curved portions of the front face of the optical element 1 and may perform two main functions. Except for the outermost SOE (e.g., SOE 5), a first function is to provide a flat front face by compensating (e.g., “filling in”) recessed curvature of the curved portions of the outer front face of the optical element 1. FIG. 5 illustrates a front perspective view of the optical element showing annular recesses for the SOEs on the front face of the optical element 1. To illustrate an example of a shape of the front face of the optical element 1, the SOEs are not shown in FIG. 5, however, when the annular recesses are filled with respective correspondingly shaped annular SOEs, the overall optical assembly may have a flat front face. Note that the entire front face of the optical assembly need not be flat, however, flat (perpendicular to the optical axis of the optical system) surfaces for the respective SOEs may provide optical benefits described below.

A second function of the SOEs 3, 4, and 5 is to switch between FOV channels respectively generated by a focal system with a pair of mirrors and one or more of afocal systems with one or more respective pairs of mirrors integrated into the optical element 1, as described above.

It should be noted that the above-mentioned two functions may be simultaneously implemented by all SOEs except the last (outermost) SOE. The last SOE, which is the SOE closest to an outer edge of the front face of the optical element, may be arranged on a flat surface of the optical element rather than the curved portion of the front face. A last SOE of FIG. 1 may correspond to the SOE 5. However, the outermost SOE is not required to be flat. For example, an embodiment may omit SOE 5 (and corresponding structure of the optical element), or SOE 5 may be curved.

The SOEs may be made of the same optical material as the main optical element, and/or they may have a same or close index of refraction.

A characteristic that at least one optical surface of each SOE (e.g., an outward front-facing surface) is flat may enable external incident light for a selected FOV to enter a corresponding “open” SOE with little or no aberration. Another (inner) optical surface of non-flat (e.g., non-outermost) SOEs may have a same curvature as the annular convex (recessed) front optical surfaces of each of the respective above-described afocal systems with pairs of front and rear mirrors. In addition, each SOE may have exactly the same shape and size as the corresponding curved annular recessed portion of the front face of the optical element 1 such that there is no gap between a back surface of an SOE and the front surface of the corresponding curved annular recessed portion of the front face of the optical element. Accordingly, it may be possible to minimize or prevent refraction of light that enters the optical element through each non-flat SOE.

Each SOE may relate to each FOV channel since the optical surface of each afocal system has a different curvature. As described above, as a non-limiting example, the last SOE (closest to the outer edge of the optical element 1) may have no curvature (or has a flat “curvature”) since all of its surfaces are substantially flat. In some embodiments, such an outermost flat SOE may not include a “filler” of optical material (matching the main element) as there may not be a corresponding annular recess in the front face of the main optical element. Of course, such an outermost optical surface is not required; the outermost optical surface may be curved or substantially flat, depending on implementation.

Switching a state (“open”/“closed”) of each SOE may be implemented by a special optical coating (in particular, a second optical coating which is generally applied to a concave (or flat with respect to the last SOE) optical surface) applied to one of optical surfaces of an SOE. That is, the switchable optical coating may be applied the surfaces of the SOEs that meet the outer surface of the optical element. This allows an SOE, when “closed”, to both block external incident light and internally reflect internal incident light.

With this optical coating, an optical surface of each SOE may have two states:

(a) transparent (“open”)

(b) reflective (“closed”).

In the state (a), an SOE may transmit external light incident to the main optical element of the optical assembly.

In the state (b), SOE may function as a second mirror in its respective afocal system with two mirrors and block external light incident to the main optical element for its respective FOV channel.

In addition, each SOE may have electrochromic glass (ECG) on a flat optical surface corresponding to the front face of the optical element 1. The ECG may further block external light incident on each of the “closed” FOV channels.

The last SOE (as a non-limiting example, the one arranged closest to the outer edge of the optical element 1) may only have this function, as it may not need to function as an internally-facing mirror.

A structure of the optical element 1 may have following characteristics.

The front central face (optical surface) and the rear faces (optical surfaces) of the optical element 1 may have mirror coatings 2 as illustrated in FIG. 1 and act as internal mirrors.

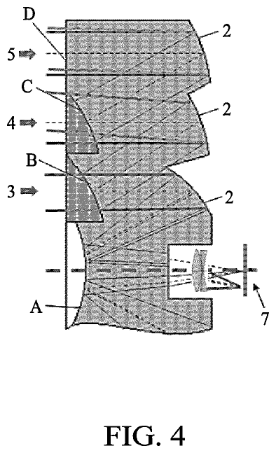

FIG. 4 is a cross-sectional view illustrating an example of a portion of an optical assembly of which a surface to which a switching optical coating is applied is referenced. Referring to FIG. 4, in an example of an optical assembly, an LCSM coating may be applied to a concave (physically, convex optically) optical surface arranged on a curved portion of a front face of the optical element 1. Reference numeral 2 of FIG. 4 indicates mirror coatings of a rear surface of the optical element 1. Reference A of FIG. 4 indicates a concave (from the front, “convex” internally) portion of a center of the front face of the optical element 1, and one of the mirror coatings 2 may also be applied to this portion.

References B, C and D indicate concave (relative to the front, “convex” relative to the interior) optical surfaces on the curved portion of the front face of the optical element 1 coated with an LCSM. These surfaces may have one of two states. In one state (photopic transmittance >87%), the surfaces may transmit light, and in another state (photopic reflectance >87%), the surfaces may act as mirrors.

As illustrated in FIG. 4, with respect to selected FOV channels (FOV1 to FOV3) respectively generated by the SOEs 3, 4, and 5, a state of the LCSM may be characterized as follows:

FOV1 (SOE 3): B—transmitting, C and D—reflecting;

FOV2 (SOE 4): C—transmitting, B and D—reflecting;

FOV3 (SOE 5): D—transmitting, B and C—reflecting.

These states are also summarized in FIG. 6.

Thus, in an example of the optical assembly, the “switching” of the FOV channels may be implemented using the LCSM, and the state of the LCSM may be switched between a transmissive state and a reflective state. However, as an optical material that implements such switching, the LCSM may have drawbacks, such as, in particular, imperfect distinction between transmissive and reflective states, generation of “noise”, and image artifacts. In this regard, in order to at least partially compensate for these drawbacks of the LCSM, the above-mentioned ECG, which may be arranged in front of each SOE that generates an FOV channel, may be used.

As described above, the mirror coatings may be applied to the rear face and the surface A of the optical element 1 and act as mirrors.

In another example, the surfaces B and C of FIG. 4 may be applied with a semi-reflective coating (50% light transmittance, 50% light reflectance). The surface B may transmit external light corresponding to the FOV1 channel and reflect internal light corresponding to the FOV2 and FOV3 channels. The surface C may transmit light corresponding the FOV2 channel and reflect light corresponding to the FOV3 channel.

The ECG may be applied to a first optical surface, which is arranged on a plane of the front face of the optical element 1, of the SOEs 3, 4, and 5. The ECG may be configured to switch between a state in which external incident light is transmitted (a transmissive state) and a state in which external incident light is absorbed (an absorptive state). In a state in which only the ECG of one SOE (and FOV channel) transmits incident light and the ECG of other SOEs absorbs light, an image sensor of an imaging device may only receive light corresponding to the one FOV channel.

As illustrated in FIG. 4, with respect to the selected FOV channels (FOV1 to FOV3) respectively provided by the SOEs 3, 4, and 5, a state of the ECG may be characterized as follows:

FOV1: B—transmitting, C and D—absorbing;

FOV2: C—transmitting, B and D—absorbing;

FOV3: D—transmitting, B and C—absorbing.

A semi-transparent coating may be merely 50% efficient, system transmittance may be significantly reduced, and there may be artifacts. This may be somewhat offset by using the above described ECG. However, using a semi-transparent coating may be a cost-effective way to implement some embodiments of the optical system.

The optical assembly may have only two SOEs (SOE 3 and SOE 4) corresponding to two FOV channels (FOV1 and FOV2).

To generate an image with an FOV (FOV1) in the image sensor of the imaging device including the optical assembly, the SOE 4 may block external incident light, and the SOE 3 may transmit the external light (“external” as used herein is relative to the optical element; there may be other optical components between the optical element and the light coming from a scene/subject, e.g., filters, films, other lenses, etc.). External light of the FOV1 channel may be incident on the optical element 1 through a flat surface and pass through a concave surface without refraction because an optical material of the SOE 3 and that of the optical element 1 are the same (or have a same index of refraction). As illustrated in FIG. 4, the light transmitted through the SOE 3 may be reflected from a mirror coating of the rear face of the optical element 1 and a mirror coating of an inner side surface of the optical surface A of the optical element 1, and the light may reach a surface of the image sensor of the imaging device in which the optical assembly is implemented, when exiting the rear of the optical element 1.

To generate the FOV2 channel, the SOE 3 may block the external incident light, and the SOE 4 may transmit the external incident light. As such, with two switching optical elements (SOE 3 and SOE 4), the SOE 4, if, for example, is implemented as the SOE arranged closest to the outer edge of the front face of the optical element 1, may have a flat surface instead of a concave optical surface. The light corresponding to the FOV2 channel may be incident on the optical element 1 through the flat surface of SOE 4. Then, the light may be internally reflected from each of concave surfaces of the rear face of the optical element 1 and the inner side surface of the physically/externally concave (optically/internally convex) optical surface A of the optical element 1, as illustrated in FIG. 4. The rear face of the optical element 1 may form an afocal system with two mirrors with a magnification M together with the concave surface of the optical element 1. The light may be internally reflected from the optical surface A of the SOE 3 and then reach the surface of the image sensor of the imaging device in which the optical assembly is finally implemented along an optical path corresponding to the FOV1 channel.

Only some structures of the solid main optical element 1 are exemplified. Table 1 below shows examples of structural parameters that may enable production of the solid main optical element 1 which implements one focal system with two mirrors and two afocal systems with two mirrors within one solid optical element.

An optical system may provide three FOV channels and also provide sufficient image quality for a pixel size of most current image sensors.

Table 1 shows structural parameters of the optical element with an image plane curvature correction element.

TABLE 1

| | Radius of | | | | | | | |
|---|---|---|---|---|---|---|---|---|
| | curvature, R, | Axial | | | Aspherical | Aspherical | Aspherical | Aspherical |
| | millimeters | distance, d, | Optical | Conical | coefficient | coefficient | coefficient | coefficient |
| AS | (mm) | mm | material, n; v | constant, K | A4 | A6 | A8 | A10 |
| 1 | ∞ | 6.3518 | 1.86; 40.578 | | | | | |
| 2** | −36.8117 | −5.2887 | Mirror | −1.00E+00 | | | | |
| 3** | −26.2319 | 4.9648 | Mirror | −1.00E+00 | | | | |
| 4* | −28.1310 | −5.3338 | Mirror | −1.00E+00 | | | | |
| 5* | −17.4579 | 5.0836 | Mirror | −1.00E+00 | | | | |
| 6 | −19.3837 | −5.6338 | Mirror | −2.15E+00 | | | | |
| 7 | −21.4135 | 3.1561 | Mirror | −5.16E+01 | 1.90E−04 | −1.42E−05 | | |
| 8 | 6.4373 | 0.9543 | | −1.52E+01 | 1.82E−03 | −3.05E−03 | 2.73E−04 | |
| 9 | 5.5788 | 0.3392 | 1.67; 19.245 | 1.06E+01 | −1.07E−01 | 3.73E−02 | −3.07E−03 | −1.41E−03 |
| 10 | 2.0266 | 0.3157 | | 1.39E+00 | −1.44E−01 | 6.47E−02 | −1.65E−02 | 7.47E−03 |
| 11 | 3.7308 | 0.5311 | 1.73; 40.508 | −1.25E+01 | −3.82E−02 | −1.30E−02 | −3.63E−03 | 4.42E−03 |
| 12 | −4.8640 | 0.0701 | | −2.47E+37 | −6.11E−02 | −8.83E−03 | 7.21E−03 | −1.03E−05 |
| 13 | 20.8070 | 0.5664 | 1.74; 49.296 | −3.91E+02 | −3.98E−02 | −7.67E−03 | 1.32E−05 | −2.17E−03 |
| 14 | −7.6181 | 0.1154 | | 2.91E+01 | −2.39E−02 | −3.01E−02 | 1.14E−02 | −1.12E−03 |
| 15 | ∞ | 0.1000 | 1.517; 64.198 | | | | | |
| 16 | ∞ | 0.1000 | | | | | | |
| 17 | ∞ | | | | | | | |

AS denotes an aperture stop, n denotes a refractive index with respect to a wavelength (d=0.586 micrometers (μm)), and v denotes an Abbe number.

A surface used for optical calculation is an aspheric surface and may be described by Equation 1.

$$Z = \frac{{cr}^{2}}{1 + \sqrt{1 - ( 1 + k ) {c}^{2} {r}^{2}}} + {A}_{4} {r}^{4} + {A}_{6} {r}^{6} + {A}_{8} {r}^{8} + {A}_{10} {r}^{10} \qquad Equation 1$$

r denotes a radius coordinate, c denotes a surface curvature value, c=1/R, R denotes radius of curvature, k denotes a conical constant, and A₄, . . . A₁₀ each denotes an aspherical coefficient.

A factor potentially significantly affecting image quality for the optical system may be a module of transfer function (MTF) value.

For a generic type of image sensor such as a complementary metal-oxide-semiconductor structure (CMOS) type sensor or a charged coupled device (CCD) type sensor, a target frequency may be 200 lines per mm. Accordingly, an MTF value for this frequency may be equal to or more than 0.2 (Rayleigh criterion).

An experimental test has shown that the optical assembly may help to assure an image quality that meets the criteria/factor described above. In one example implementation, an MTF value with respect to the target frequency, which is 200 lines per mm, is equal to or more than 0.2, meeting the Rayleigh criterion mentioned above in all cases. The three FOVs (FOV1 to FOV3) may provide, for example, following respective degrees of FOV.

FOV1: 10.6 degrees (stop number F # is 2.5)

FOV2: 6.6 degrees (F # is 3.16)

FOV3: 4.6 degrees (F # is 3.44)

Switching states of SOEs may be performed by connecting the SOEs to one or more of control units through electronic connectors, conductors, and the like, under the control of a controller of the imaging device in which the optical assembly is implemented.

The control units may be one or more of processors, microprocessors, application-specific integrated circuits (ASICs), and the like, and it may be understood that the control units may control the optical assembly under the control of any combination of software, firmware, program element, module, and/or the like, stored in one or more of computer-readable media and as known by those skilled in the art.

In an example, a method of generating multiple FOVs in an imaging lens may be provided. The method may include transmitting incident light to a solid main optical element through at least two SOEs arranged on a front face of an optical element. The incident light may be reflected internally at least once due to a focal system with two mirrors integrated into the optical element and one or more of afocal systems with two mirrors integrated into the optical element and be out-coupled onto an image sensor to generate an image with multiple FOVs in the image sensor. Each of at least two SOEs may be configured to switch between an open state in which an SOE transmits light and a closed state in which the SOE reflects and/or absorbs the light to switch each FOV in the image sensor.

A method of providing a plurality of FOVs in an imaging lens may be implemented by the optical assembly described above, and the method may be used in the imaging device described above.

In a first stage of the method, based on an image with at least one FOV being provided in the image sensor, incident light may be transmitted by one of the at least two SOEs switched to be in a light transmission state. Switching between FOVs in the image sensor may be performed depending on an “open” or “closed” state of each SOE.

For example, referring back to FIGS. 1 through 5, in response to the SOE 3 being switched to an “open” (transparent) state and the SOEs 4 and 5 being in a “closed” state, the incident external light may enter the optical element 1 through the SOE 3. In response to the SOE 4 being in an “open” state and the SOEs 3 and 5 being in a “closed” state, the incident external light may enter the optical element 1 through the SOE 4. In response to the SOE 5 being in an “open” state and the SOEs 3 and 4 being in a “closed” state, the incident external light may enter the optical element 1 through the open SOE 5. It may be appreciated that any materials, construction, etc., may be used to control optical transmissivity, including various optically-switchable films or solid components (optically switchable by current, electric/magnetic field, etc.), may be used.

In a subsequent stage of the method, the light transmitted into the optical element may be reflected internally at least once in the optical element. To generate a first (wide) FOV, the method may use a focal system with two mirrors integrated into the optical element, and the method may be implemented by a pair of optical surfaces including a central surface of a front face of the optical system and a surface of each of rear faces of the optical element. To generate a second FOV, a third FOV, or the like, the method may use at least one focal system with two mirrors. Implementation and an operating principle of the method is described, in particular, in FIG. 3. At least one afocal system with two mirrors may be provided to the optical element, and a number of afocal systems may vary depending on a predetermined implementation. Accordingly, an example may provide an FOV according to a number of focal systems and afocal systems in the image sensor of the imaging device.

In a subsequent stage of the method, switching of an FOV provided to the image sensor by light external incident on the optical element and such light reflecting internally at least once may be performed. The method may be configured to change light transmission and/or blocking (reflection or absorption) in response to a low voltage current control signal output by a processor that controls the imaging device. The switching may be performed by each SOE by switching a state from “open” to “closed” and vice versa using at least one optical surface in SOEs and/or the optical element.

Through the technical solution described above, one or more of the following technical effects may be achieved, depending on implementation. Changing (“magnifying/reducing”) of an FOV in an optical system (an optical node) may be performed without using moving components in the optical system, such components requiring highly precise manufacturing, adjustment, one or more motors, etc. Thus, the optical system may enable generation of a particularly compact imaging device suitable for use in a modern compact user computing device such as a smartphone, tablet computer, and portable personal computer (e.g., a laptop and netbook). The optical system may be used in an imaging device, such as a compact photo/video camera having a relatively wide range of focal length (zoom). Meanwhile, as described above, the optical system may minimize geometrical aberration and guarantee sufficiently high image quality. In addition, absence of moving components in the optical system may simplify manufacture and assembly of the imaging device including the optical system.

Hereinafter, a method according to an example configured as described above is described with reference to the drawings.

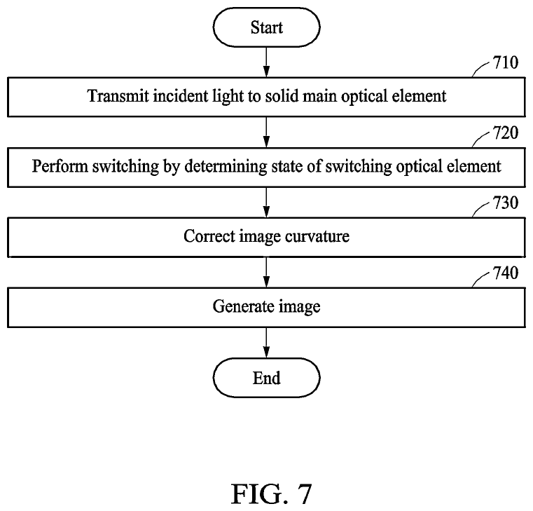

FIG. 7 is a flowchart illustrating an example of a process of providing multiple FOVs through an imaging lens, according to one or more embodiments.

Referring to FIG. 7, an imaging lens may transmit 710 incident light to a solid main optical element through either of at least two SOEs arranged on a front face of an optical element.

The imaging lens may switch 720 each FOV in an image sensor by switching each of the at least two SOEs between an open state in which an SOE mostly transmits light and a closed state in which the SOE mostly reflects and/or absorbs the light.

The imaging lens may correct 730 image curvature generated in the image sensor using an image plane curvature correction element arranged between the optical element and the image sensor.

Then, as light of which image curvature is corrected may be out-coupled onto the image sensor through the image plane curvature correction element, the imaging lens may generate 740 an image with multiple FOVs in the image sensor.

Meanwhile, operation 730 may be omitted when correction of image curvature is not necessary, as may be the case for different applications.

The external incident light passed through an SOE in operation 710 may be reflected internally at least once due to a focal system with two internal-facing mirrors integrated into the optical element and one or more of afocal systems with two mirrors integrated into the optical element and be out-coupled onto the image sensor. The image sensor may generate the image with multiple FOVs depending on switching of the SOEs.

In operation 720, the switching of the SOEs may mean that when one of the at least two SOEs is switched to an open state, the other SOE(s) may be switched to a closed state.

The computing apparatuses, the electronic devices, the processors, the memories, the image sensors, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An optical assembly, comprising:
an optical element provided in a form of a solid main optical element and comprising an integrated focal system with two mirrors and at least one integrated afocal system with two mirrors;
a plurality of switching optical elements (SOEs) arranged on a front face of the optical element and configured to switch between an open state in which light is transmitted and a closed state in which light is reflected and/or inhibited; and
an image plane curvature correction element.

2. The optical assembly of claim 1, wherein the focal system comprises a first concave reflective optical surface and a second convex reflective optical surface.

3. The optical assembly of claim 2, wherein the at least one afocal system comprises at least a first concave reflective optical surface and a second convex reflective optical surface.

4. The optical assembly of claim 3, wherein the first concave reflective optical surface and the second convex reflective optical surface are applied with a coating of which a state can change between a transmission state and a reflection state.

5. The optical assembly of claim 1, wherein the focal system and the at least one afocal system are provided in the solid main optical element.

6. The optical assembly of claim 1, wherein the SOEs are configured to compensate for curvature of at least one concave surface of the afocal system to form a substantially flat forward face portion of the optical element.

7. The optical assembly of claim 1, wherein at least one surface of the SOEs is applied with a reflective optical coating.

8. The optical assembly of claim 1, wherein at least one surface of the SOEs is applied with an electrochromic glass (ECG) coating.

9. The optical assembly of claim 7, wherein the SOEs are made of a same optical material as the main optical element.

10. The optical assembly of claim 7, wherein the SOEs have a flat first optical surface and a second optical surface having curvature corresponding to curvature of a concave optical reflective surface of the focal system and/or the at least one afocal system.

11. The optical assembly of claim 7, wherein the SOEs are arranged on a second reflective optical surface of the at least one afocal system to form a flat surface arranged perpendicular to an optical axis.

12. The optical assembly of claim 7, wherein the optical element has a recessed concave central circular portion.

13. The optical assembly of claim 1, wherein the image plane curvature correction element is provided in a form of at least one lens arranged between the optical element and an image sensor of an imaging device.

14. An imaging device comprising an optical assembly, wherein the optical assembly comprises:
a front side comprising:
a first annular portion comprising a first optical switch configured to control transmissivity of the first annular portion; and
a second annular portion comprising:
an annular recess with an internally-convex surface, and
a second optical switch configured to control turn mirroring of the internally-convex surface on and off; and
a rear side comprising:
a third annular portion comprising a first internally-concave mirrored surface configured to reflect light transmitted through the first annular portion.
a fourth annular portion comprising a second internally-concave mirrored surface configured to reflect light transmitted through the second annular portion.

15. A method of generating multiple fields of view (FOVs) in an imaging lens, the method comprising:
transmitting light incident to a solid main optical element through two switching optical elements (SOEs) arranged on a front face of an optical element; and
switching between which FOV is provided to an image sensor by switching each of the two SOEs between an open state in which the SOEs transmit light and a closed state in which the SOEs reflect and/or inhibit light transmission,
wherein, in the transmitting of the light incident to the solid main optical element, the incident light is reflected internally at least once due to a focal system with two mirrors integrated into the optical element and at least one afocal system with two mirrors integrated into the optical element, and is out-coupled onto the image sensor to provide multiple FOVs for the image sensor.

16. The method of claim 15, further comprising:
correcting image curvature generated in the image sensor using an image plane curvature correction element arranged between the optical element and the image sensor.

17. The method of claim 15, wherein the switching between of each of the FOVs comprises switching one of the SOEs to the open state and switching the other SOE to the closed state.

18. The method of claim 15, wherein the SOEs are configured to compensate for recessed curvature of at least one concave surface of the afocal system to form a substantially flat forward face of the optical element.

19. The method of claim 15, wherein at least one surface of the SOEs is applied with a reflective optical coating.

20. The method of claim 15, wherein at least one surface of the SOEs is applied with an electrochromic glass (ECG) coating.
